(19) United States
(12) Patent Application Publication
(10) Pub. No.: US 2004/0168185 A1
(43) Pub. Date: Aug. 26, 2004

(54) Multimedia network picture-in-picture

(76) Inventors: Thomas Patrick Dawson, Escondido, CA (US); Christopher Jensen Read, San Diego, CA (US)

Correspondence Address: MILLER PATENT SERVICES, 2500 DOCKERY LANE, RALEIGH, NC, 27606, US

(21) Appl. No.: 10/373,464

(22) Filed: Feb. 24, 2003

(51) Int. Cl. G06F 3/00; H04N 5/445; G06F 13/00

(52) U.S. Cl. 725/38

(57) ABSTRACT

A content server consistent with certain embodiments of the present invention has a mechanism for receiving a picture-in-picture communication to initiate a picture-in-picture function. A video image scaler, responsive to the picture-in-picture communication, scales a secondary video image to produce a reduced size secondary video image. A secondary video image embedder embeds the reduced size secondary video image into a main video image to produce a picture-in-picture video image. A video encoder encodes the analog picture-in-picture video image into a digital video format to produce a digital picture-in-picture video image. A packetizer and streamer packetizes the digital picture-in-picture video image into Internet protocol (IP) packets to form a packetized data stream and addresses the Internet protocol packets to the target networked device prior to transmitting.

### FIELD OF THE INVENTION

This invention relates generally to the field of multimedia networking. More particularly, certain embodiments consistent with this invention relate to an efficient implementation of multimedia networked picture-in-picture (PIP) function.

### BACKGROUND OF THE INVENTION

As the cost of computing power and networking equipment declines, multimedia devices such as home entertainment equipment is gradually becoming networked along with other network enabled equipment within a consumer's household. This opens up possibilities for enhanced distribution of entertainment content throughout a household.

With both wired and wireless network implementations, multimedia applications can demand large amounts of the network's available bandwidth to distribute content from a server or other source to a client playback device situated in the network. When multiple playback devices are operating at the same time, the network's bandwidth may be taxed. When one device is operating in a conventional picture-in-picture mode, it may require twice the network bandwidth that it otherwise would use. Accordingly, even with the emergence of ultra-wideband networking, the available bandwidth should be used judiciously wherever possible.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a block diagram of a portion of a home network consistent with certain embodiments of the present invention.

FIG. 2 illustrates an exemplary video image in a PIP mode.

FIG. 3 depicts a communication flow diagram consistent with certain embodiments of the present invention.

FIG. 4 is a flow chart describing a PIP process consistent with certain embodiments of the present invention.

FIG. 5 is a block diagram of an exemplary content server architecture supporting an embodiment consistent with the present invention.

FIG. 6 is a block diagram of an exemplary analog domain PIP circuit consistent with certain embodiments of the present invention.

FIG. 7 is a block diagram of an exemplary digital domain PIP circuit consistent with certain embodiments of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

Embodiments consistent with the present invention may be realized in any number of ways to accommodate analog or digital video signals in various formats. Accordingly, the term “video image” and similar terms as used herein may infer either that the image is represented by a digital video signal or by an analog video signal. It will be understood by those skilled in the art, upon consideration of the present teaching, that the present invention can be suitably modified to deal with various analog and digital video signals that comply with various standards, present and future, without departing from the present invention.

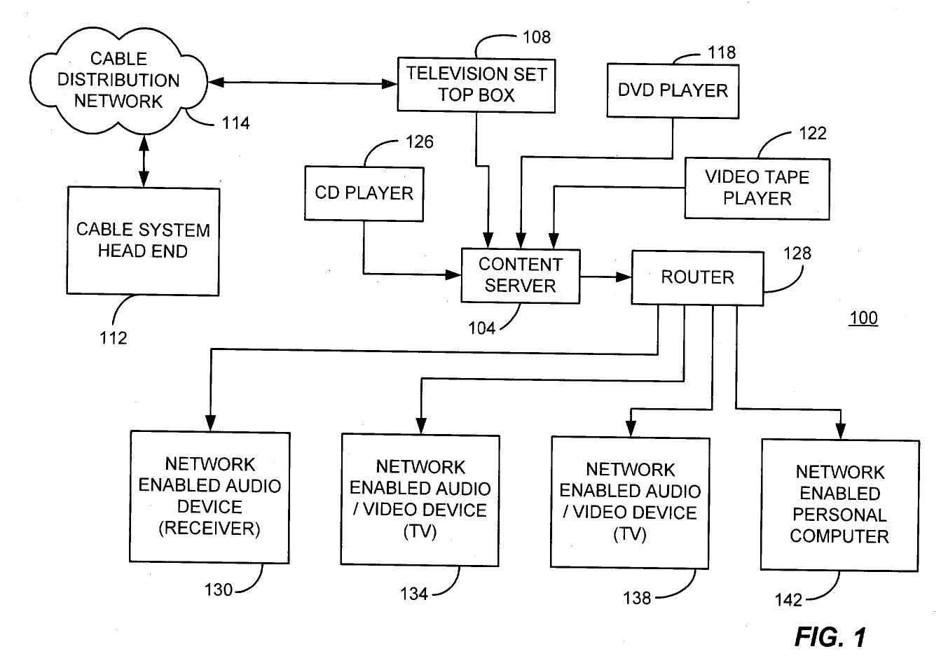

Turning now to FIG. 1, an exemplary home multimedia network 100 is depicted. In this exemplary embodiment, a client-server architecture is used with a content server 104 serving as a source or gateway to content that is distributed to various client devices. Content can be sourced from any number of sources including, but not limited to, a television STB 108, such as that used to select an analog video channel or satellite television system to a television analog video signal. In this example, STB 108 receives content from a cable system head end 112 via a cable distribution network 114, and delivers such content to server 104. In one embodiment consistent with the present invention, the system may receive content from devices that use a digital video format such as JVT (Joint Video Team) or MPEG-4 (Moving Pictures Expert Group).

The server 104 is also able to receive content from other sources such as DVD (digital versatile disc) player 118, video tape player 122 and CD (compact disc) player 126. The content server 104 then utilizes an internal or external router 128 to route the content to a selected client playback device that us addressed by an appropriate address on the network (e.g., an Internet protocol address) such as devices 130, 134, 138 and 142 which are connected to the network either by, for example, a wired ethernet connection or by a wireless“connection such as a bluetooth connection, an IEEE 802.11 (a) or (b) connection, ultra-wideband (UWB) connection (for example as is being standardized by the ulltra-wideband working group—UWBWG), or other suitable connection that permits the devices to be addressed selectively according to an assigned Internet Protocol (IP) address. In a UWB wireless radio communication network, even multiple high definition television signals can be multiplexed over a home network system. In this example, device 130 is shown as a network enabled audio device such as a stereo receiver (i.e., no video capability). Devices 134 and 138 are shown to be network enabled television-like devices that can be addressed by an IP address to receive packets of audio and video information. Device 142 is shown to be a network enabled personal computer and can be used to receive audio, video and/or data via the IP address.

While router 128 is shown as an external component of the server 104, in other embodiments, server 104 could incorporate the router internally. It is also noted that, although a client-server structure is described, the certain embodiments consistent with the present invention can also be realized in a peer-to-peer network environment without departing from the invention.

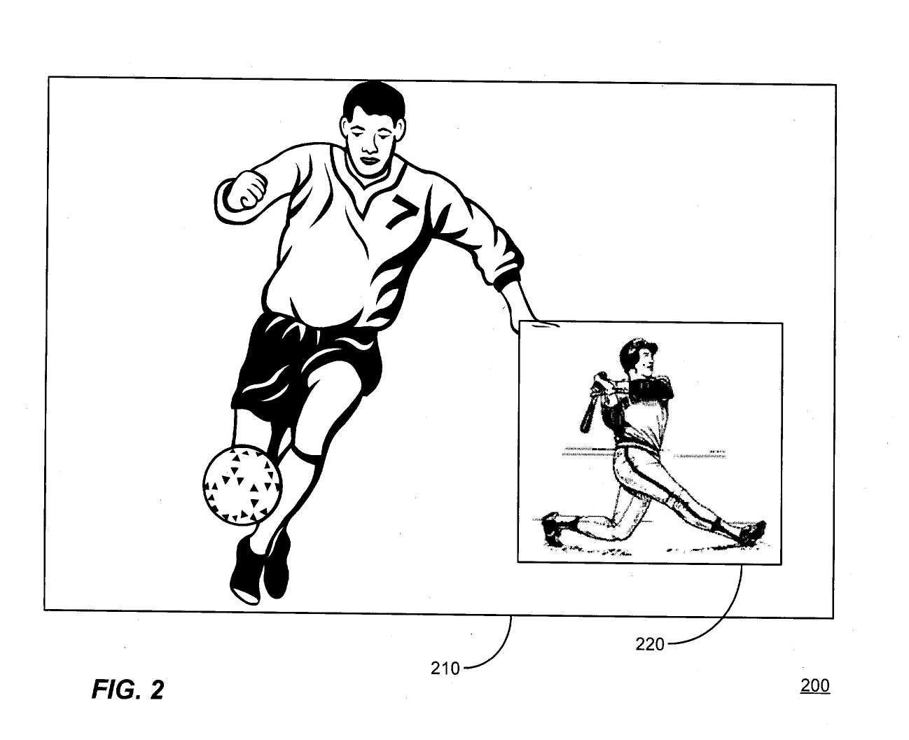

FIG. 2 illustrates a video image 200 produced in a picture-in-picture (PIP) mode of operation. In this mode of operation, image 200 is made up of a main image 210 with a secondary image 220 superimposed upon the main image 210. This operation is conventionally carried out in a television set by receipt of two full resolution images via two tuners. The television set then scales the secondary image and generates a composite image that includes both the main image 210 and the secondary image 220 overlaying the main image 210.

However, if this same scheme is utilized in a digital networked environment, twice the network bandwidth is required to generate a single PIP image. Even though UWB networks have the bandwidth to accommodate several high definition video images simultaneously, transmission of the full images is unnecessary to support a PIP function. The present invention addresses this problem in a manner that produces a PIP function while optimizing the amount of network bandwidth utilized.

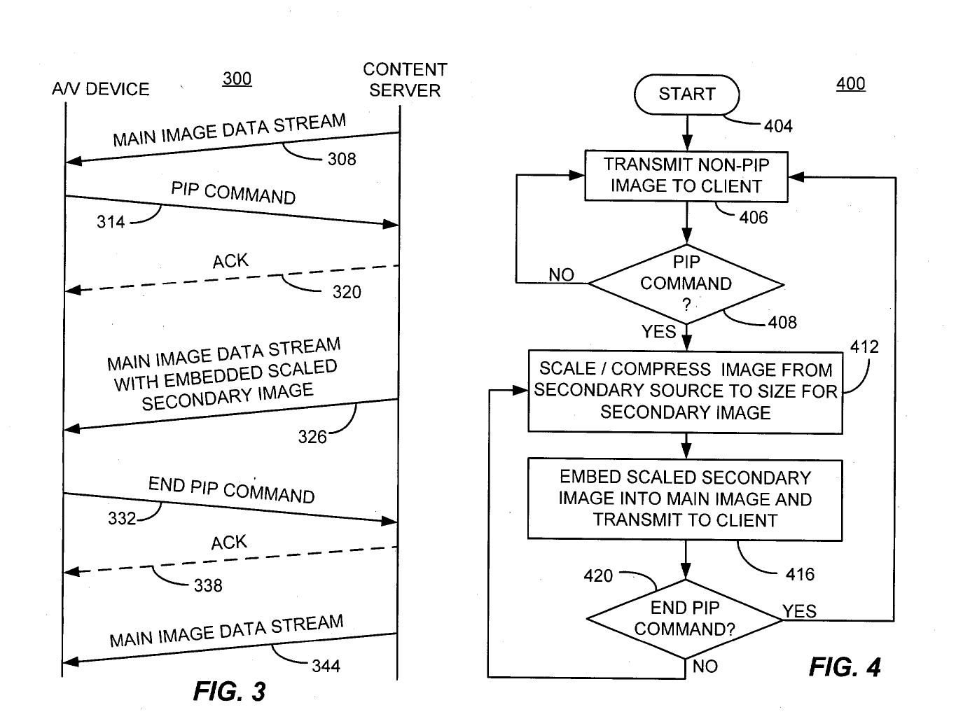

With reference to FIG. 3, an exemplary communication flow diagram 300 is depicted which describes the interaction of a client A/V (audio/video) device (e.g., device 134) with content server 104 in an embodiment consistent with the present invention. In accordance with certain embodiments consistent with the present invention, the composite PIP image is created at the content server prior to transmission to the client A/V device in order to preserve network bandwidth. This is accomplished, according to the present embodiment, by use of a set of communications as depicted in diagram 300. During normal (non-PIP) operation, a data stream 308 carrying a main image flows from the content server to the A/V device. When the user wishes to operate in the PIP mode, a PIP command 314 (or set of messages) is sent (or exchanged). In a simple embodiment, the PIP command tells the content server that to send a PIP image with an imbedded secondary image of given size and specifies the source or channel for both images as a single message 314, possibly followed by an acknowledgment communication 320.

In other embodiments, an equivalent exchange of messages can be carried out in a markup language such as XML and/or HTML (or other suitable language) commands exchanged between the server and the client. These commands may result in a dialog box or other GUI (graphical user interface) element appearing at the client in which various PIP parameters (e.g., main channel or source, secondary channel or source, location of secondary image, size of secondary image, etc.) are exchanged in a question answer format. In still other embodiments, a default size and location for the size and placement of the PIP can be used.

Once the content server is supplied with all necessary information to generate the PIP image, the secondary video image is scaled to the appropriate size and substituted for the content in the main video image that occupies the area specified for the PIP. In this manner, a composite PIP video image is generated that requires little if any more data to convey over the network than that which might be required for any single frame of video. In one embodiment, this video composite image with the embedded PIP image is in analog format which is then encoded into digital video format (e.g., such as MPEG 2) and then translated to a set of IP packets which are then transmitted over the network as 326 to a target device, e.g., specified by an IP address. In other embodiments, the secondary video image is embedded or inserted into the main video image after first being converted to digital format (such as JVT) and then the video composite image transmitted as a set of IP packets over the network as 326 to a target device (e.g., specified by the IP address) Such transmission proceeds until such time as a command 332 is received by the content server that terminates the PIP operation. This command may optionally be acknowledged at 338. PIP operation is then discontinued and only the main image is transmitted thereafter at 344.

FIG. 4 depicts an exemplary process 400 used to carry out the PIP process as just described starting at 404. Normal operation without PIP is carried out at 406 in which a non-PIP image is transmitted to the client until such time as a PIP command or dialog is carried out at 408 in which the content server is provided with all information needed to generate the desired PIP image. When this command or dialog is complete, the secondary video image is scaled to an appropriate size at 412 and then embedded into the main video image for transmission to the client device at 416. This process at 412 and 416 continues to produce the PIP image until such time as a command or dialog that ends the PIP function is carried out at 420 at which point, control returns to 406 where transmission of non-PIP images proceeds while the process awaits the next PIP command.

Thus, in certain embodiments consistent with the present invention, a method of realizing a networked picture-in-picture function at a content server involves receiving a picture-in-picture communication to initiate a picture-in-picture function; responsive to the picture-in-picture communication scaling a secondary image to produce a reduced size secondary image; embedding the reduced size secondary image into a main image to produce a picture-in-picture image; and transmitting the picture-in-picture image to a target networked device. In certain embodiments consistent with the present invention, the method further involves first encoding the PIP video image into a digital video format and then partitioning the digital video into Internet Protocol (IP) packets to form a packetized data stream; and addressing the Internet protocol packets to the target networked device prior to transmitting. In other embodiments, the main and secondary video images may be encoded into digital format prior to scaling the secondary video image and embedding it into the main image. In other embodiments, various combinations of these techniques may be realized such as scaling the secondary video image in the analog domain, encoding it as a digital video image and then embedding it into the digitally encoded main image, for example, the secondary video image can be encoded into a digital format after being scaled as an analog video image. Other arrangements will become apparent to those skilled in the art upon consideration of the present teaching.

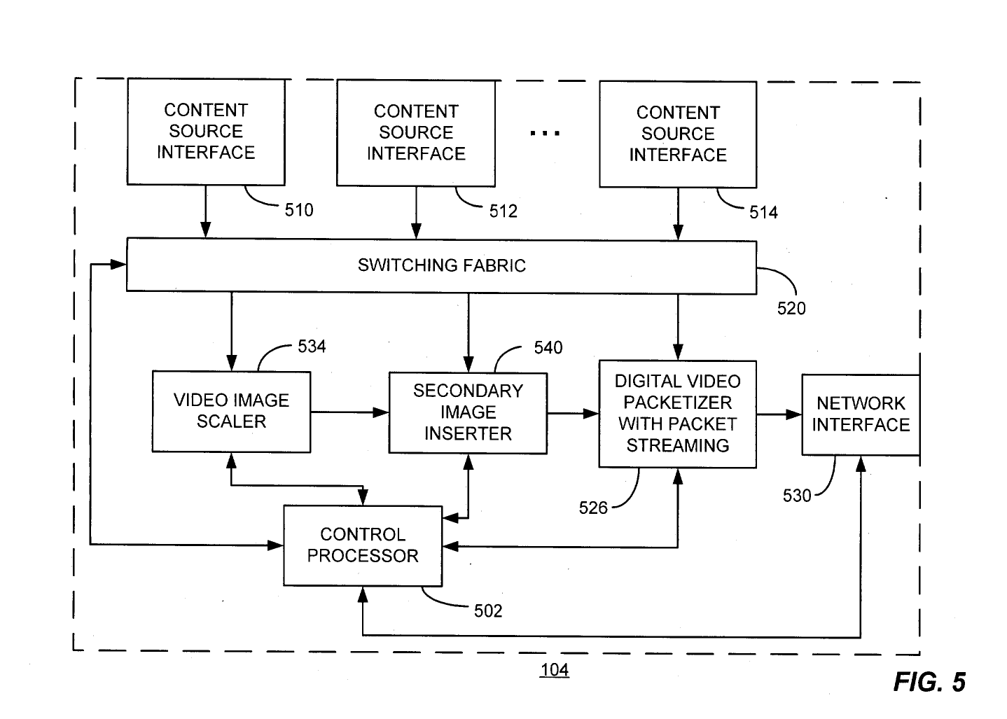

FIG. 5 depicts a functional block diagram of an exemplary embodiment of a content server 104 consistent with certain embodiments of the present invention. This functional block diagram should be considered exemplary since other realizations of the PIP function consistent with the present invention can also be devised without departing from the present invention. In this embodiment, a control processor 502 such as a programmed microcomputer oversees and controls the operation of the functional blocks of the content server. The content server 104 can receive content from any of a variety of sources of content depicted as content sources. One or more interfaces 510, 512 through 514 to such sources that provides conversion to a common format (if required) may be provided to assure that the data is placed in a common format for further processing. In some embodiments, the input format may be restricted to be an analog signal. In other embodiments, the input format may be a digital video signal given the digital video format used provides for embedding of the secondary video image into the main image (or can be adapted to do so). For purposes of this example, assume that the video interfaces 510, 512 through 514 supply analog video image signals at their output.

The content is received at the interfaces 510, 512 through 514 and provided to a set of switching and buffering circuits referred to as the switching fabric 520. The switching fabric 520, operating under the control of control processor 502, selectively switches content from one of the interfaces 510, 512 through 514 to an output. In the case of non-PIP content, an analog video signal can be switched from a selected input to a digital video packetizer with a packet streaming function such as 526 to provide for transport of a digitized video signal over the network. Packetizer 526 serves to digitize the analog video and encode the digitized video into a selected digital video format such as CCIR 601, MPEG-2, or JVT, and packetizes the digital video. Packets are then sent to the target client device via network interface 530.

When a PIP image is to be generated, as a result of a user command received at the control processor 502 (e.g., via a user command received via the network interface 530), the secondary image content is switched to a video image scaler 534. Scaler 534 reduces the size of the secondary image to the desired size and resolution (thus reducing the amount of data contained in the image), and passes the scaled image to a secondary image inserter 540. Control processor 502, further directs the switching fabric to send the main image to the secondary image inserter 540. Secondary image inserter 540 then inserts the secondary image into the main image in a location specified by the control processor 502. The composite image is then sent packetizer 526 in order to produce a stream of packetized digital video to the client device. In certain embodiments, the router 128 may be incorporated within the content server 104 and thus provide an internal routing function.

Thus, in certain embodiments consistent with the present invention, a content server consistent with certain embodiments of the present invention has a mechanism for receiving a picture-in-picture communication (e.g., via a command received over the network) to initiate a picture-in-picture function. A video image scaler, responsive to the picture-in-picture communication, scales a secondary video image to produce a reduced size secondary video image. A secondary video image inserter embeds the reduced size secondary video image into a main video image to produce a picture-in-picture video image. In one embodiment, the image is encoded into a digital video format and partitioned into IP packets. A packetizer and streamer formats the picture-in-picture image into Internet protocol (IP) packets and produces a packetized data stream. The packets are addressed using an IP address to the target networked device prior to transmitting. A network interface transmits the PIP digital video as IP packets to the target networked device.

A content server consistent with other embodiments of the present invention has a mechanism for receiving a picture-in-picture communication to initiate a picture-in-picture function. A video image scaler, responsive to the picture-in-picture communication, scales a secondary video image to produce a reduced size secondary video image. A secondary video image embedder embeds the reduced size secondary video image into a main video image to produce a picture-in-picture video image.

Those skilled in the art will appreciate, upon consideration of the present teachings, that the present invention can readily extended to provide multiple PIP inset images (i.e., multiple secondary images inserted into a main image). Similarly, the invention can be extended to provide multiple PIP composite images to multiple target devices without departing from the present invention. Other modification will also occur to those skilled in the art upon consideration of the present teachings without departing from the invention.

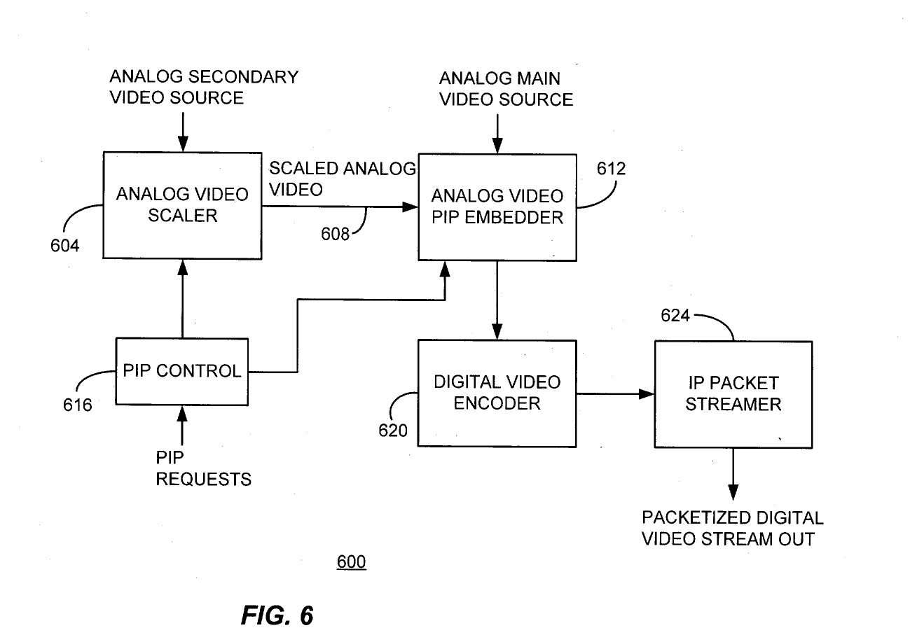

As previously discussed, the PIP process of the present invention can be carried out using either analog or digital video techniques or combinations thereof. FIG. 6 depicts a circuit 600 that can be used to carry out the PIP process in the analog domain. An analog secondary video image is received from an analog secondary video source at analog video scaler 604. Scaler 604 produces a scaled analog video image at 608, for example, in a manner similar to that used in analog television PIP image scaling circuits. This scaled secondary video image is supplied to an analog video PIP embedder 612 that also receives an analog video input from an analog main video image source. Embedder 612 then carries out an embedding process, again similar to an analog PIP image embedding process carried out in an analog television set. The scaler 604 operates under control of a PIP control circuit 616 that sends commands to the scaler 604 to control the size of the scaled secondary video image. PIP control circuit 616 further controls embedder 612 to determine the location of the scaled image in the PIP image. PIP control circuit 616 issues these control commands in response to PIP request parameters that are received externally.

The output of embedder 612 is an analog PIP video image that is then sent to a digital video encoder 620 where the analog PIP video image is converted to a packetized digital format. The digital format video is then processed by an IP packet streamer 624 to produce the stream of IP format packets destined for the client device.

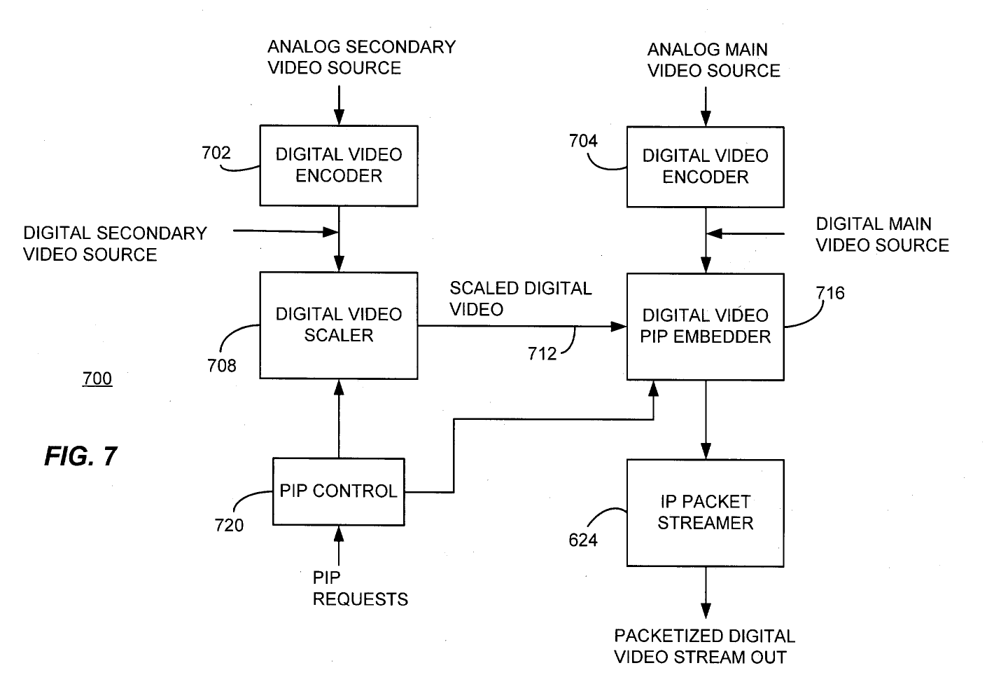

FIG. 7 depicts a circuit 700 that can be used to carry out the PIP process in the digital domain based upon either digital or analog video inputs. An analog secondary video image is first converted to the digital domain by a digital video encoder 702. Similarly, an analog main video signal is converted to a digital video signal at 704. The digital secondary video image from encoder 702, or alternatively, from a digital secondary video source, is received at digital video scaler 708. Scaler 708 produces a scaled analog video image at 712, using any suitable digital image scaling technique suitable for the digital video format in use. This scaled secondary video image is supplied to a digital video PIP embedder 716 that also receives a digital video input from digital video encoder 704, or alternatively directly receives the digital main video from a digital source. Embedder 716 then carries out a digital embedding process in any suitable manner compatible with the digital encoding method in use. The scaler 708 operates under control of a PIP control circuit 720 functioning much like PIP controller 616 in that it sends commands to the scaler 708 to control the size of the scaled secondary video image. PIP control circuit 720 further controls embedder 716 to determine the location of the scaled image in the PIP image. PIP control circuit 720 similarly issues these control commands in response to PIP request parameters that are received externally. The output of embedder 716 is a digital PIP video image that is then sent to an IP packet streamer 624 to produce the stream of IP format packets destined for the client device.

Thus, embedding of a secondary video image into a primary video image can be carried out using any suitable analog or digital embedding technique. For example, known analog and digital techniques can be used for analog video images and JVT encoded digital video images. MPEG 2 are more complex to carry out a PIP operation on directly due to the intra-frame coding used in this format. However, MPEG 2 video images can be translated to analog or JVT or another suitable format to facilitate the embedding. Other techniques for directly manipulating MPEG 2 video images may also be possible and are within the scope of the present invention.

Those skilled in the art will recognize that certain embodiments of the present invention can be based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps and associated data used to implement the embodiments described above can be implemented using disc storage as well as other forms of storage such as for example Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention, as described in certain embodiments herein, can be implemented using a programmed processor executing programming instructions that are broadly described above in flow chart form that can be stored on any suitable electronic storage medium or transmitted over any suitable electronic communication medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of realizing a networked picture-in-picture (PIP) function at a content server, comprising:
receiving a picture-in-picture communication that initiates a picture-in-picture function,
responsive to the picture-in-picture communication scaling a secondary video image to produce a reduced size secondary video image;
embedding the reduced size secondary video image into a main video image to produce a picture-in-picture video image; and
transmitting the picture-in-picture video image to a target networked device.

2. The method according to claim 1, wherein the picture-in-picture video image comprises an analog picture-in-picture video image.

3. The method according to claim 2, further comprising:
encoding the analog picture-in-picture video image into a digital video format to produce a digital picture-in-picture video image;
formatting the digital picture-in-picture video image into Internet protocol (IP) packets to form a packetized data stream; and
addressing the Internet protocol packets to the target networked device prior to transmitting.

4. The method according to claim 3, wherein the digital video format comprises one of a JVT compliant format and an MPEG compliant format.

5. The method according to claim 1, wherein the picture-in-picture video image comprises a digital picture-in-picture video image.

6. The method according to claim 5, further comprising:
formatting the digital picture-in-picture video image into Internet protocol (IP) packets to form a packetized data stream; and
addressing the Internet protocol packets to the target networked device prior to transmitting.

7. The method according to claim 5, wherein the digital picture-in-picture video image is formatted as one of a JVT compliant format and an MPEG compliant format.

8. The method according to claim 1, wherein the picture-in-picture communication comprises a command to the content server.

9. The method according to claim 8, wherein the command specifies a location and size of the secondary video image.

10. The method according to claim 1, wherein the picture-in-picture communication comprises a dialog in which a location and size of the secondary image is specified.

11. The method according to claim 10, wherein the dialog is implemented using a markup language.

12. The method according to claim 1, further comprising the content server sending an acknowledgment message in response to the picture-in-picture communication.

13. The method according to claim 1, wherein the picture-in-picture video image is created using a default size and location for the secondary video image.

14. The method according to claim 1, wherein the transmitting comprises routing the picture-in-picture video image to a target networked device based upon an Internet Protocol address.

15. A computer readable storage medium storing instructions which, when executed on a programmed processor, carry out a method of realizing a networked picture-in-picture function at a content server according to claim 1.

16. A content server, comprising:
means for receiving a picture-in-picture communication to initiate a picture-in-picture function;
a video image scaler that, responsive to the picture-in-picture communication scales a secondary video image to produce a reduced size secondary video image;
a secondary video image embedder that embeds the reduced size secondary video image into a main video image to produce a picture-in-picture video image; and
a network interface that transmits the picture-in-picture video image to a target networked device.

17. The content server according to claim 16, wherein the picture-in-picture video image comprises an analog picture-in-picture video image.

18. The content server according to claim 17, further comprising:
a video encoder that encodes the analog picture-in-picture video image into a digital video format to produce a digital picture-in-picture video image;
a packetizer and streamer that packetizes the digital picture-in-picture video image into Internet protocol (IP) packets to form a packetized data stream and addresses the Internet protocol packets to the target networked device prior to transmitting.

19. The content server according to claim 18, wherein the digital video format comprises one of a JVT compliant format and an MPEG compliant format.

20. The content server according to claim 16, wherein the picture-in-picture video image comprises a digital picture-in-picture video image.

21. The content server according to claim 20, further comprising:
a packetizer and streamer that packetizes the digital picture-in-picture video image into Internet protocol (IP) packets to form a packetized data stream, and addresses the Internet protocol packets to the target networked device prior to transmitting.

22. The content server according to claim 20, wherein the digital picture-in-picture video image is formatted as one of a JVT compliant format and an MPEG compliant format.

23. The content server according to claim 16, wherein the picture-in-picture communication comprises a command to the content server.

24. The content server according to claim 23, wherein the command specifies a location and size of the secondary image.

25. The content server according to claim 16, wherein the picture-in-picture communication comprises a dialog in which a location and size of the secondary image is specified.

26. The content server according to claim 25, wherein the dialog is implemented using a markup language.

27. The content server according to claim 16, wherein the content server sends an acknowledgment message in response to the picture-in-picture communication.

28. The content server according to claim 16, further comprising switching means for switching a signal the video image scaler as a secondary video image.

29. The content server according to claim 28, wherein the switching means further switches a signal representing the main video image to the secondary video image embedder.

30. The content server according to claim 16, further comprising a router connected to the network interface for routing the picture-in-picture video image to a target network device based upon an Internet Protocol address.

31. A content server, comprising:
a user interface receiving a picture-in-picture communication to initiate a picture-in-picture function, wherein the picture-in-picture communication specifies a location and size of the secondary video image;
a video image scaler that, responsive to the picture-in-picture communication scales a secondary video image to produce a reduced size secondary video image;
a secondary image embedder that embeds the reduced size secondary video image into a main video image to produce a picture-in-picture video image;
switching means for switching a signal carrying content to the video image scaler as the secondary video image and for switching a signal carrying content representing the main video image to the secondary video image embedder;
a packetizer and streamer that formats the picture-in-picture image into Internet protocol (IP) packets to form a packetized data stream, and that addresses the Internet protocol packets to the target networked device prior to transmitting;
a router;
a network interface that transmits the picture-in-picture image to the router; and
wherein the router routes the picture-in-picture video image to a target networked device based upon an Internet Protocol address.

32. The content server according to claim 31, further comprising a video digital video encoder that encodes the picture-in-picture video image into a digital format prior to formatting to IP packets.

33. The content server according to claim 31, wherein the main video image is in a digital format.

34. The content server according to claim 31, wherein the secondary video image is in a digital format.

35. The content server according to claim 31, wherein the secondary video image is encoded into a digital format after being scaled as an analog video image.

36. The content server according to claim 31, wherein the main video image is encoded into a digital format prior to embedding the secondary video image.

37. The content server according to claim 31, wherein the secondary video image is an analog video image that is scaled as an analog video image, and wherein the main video image is also an analog video image, and wherein the embedding is carried out on the analog images to produce an analog picture-in-picture video image.

38. The content server according to claim 37, further comprising a digital video encoder that encodes the analog picture-in-picture video image into a digital format.

39. The content server according to claim 31, wherein the picture-in-picture communication comprises a command to the content server.

40. The content server according to claim 31, wherein the picture-in-picture communication comprises a dialog in which a location and size of the secondary image is specified.

41. The content server according to claim 31, wherein the content server sends an acknowledgment message in response to the picture-in-picture communication.
